(19) United States
(12) Patent Application Publication
(10) Pub. No.: US 2017/0012680 A1
(43) Pub. Date: Jan. 12, 2017

(54) Instantaneous Communications Systems

(71) Applicant: University of Hawai'i, Office of Technology Transfer and Economic Development, Honolulu, HI (US)

(72) Inventors: John M. J. Madey, Honolulu, HI (US); Julius M. J. Madey, Hillsdale, NY (US)

(21) Appl. No.: 15/071,025

(22) Filed: Mar. 15, 2016

Related U.S. Application Data
(60) Provisional application No. 62/307,316, filed on Mar. 11, 2016.
(60) Provisional application No. 62/134,525, filed on Mar. 17, 2015.

(51) Int. Cl. H04B 7/04

(52) U.S. Cl. CPC H04B 7/0408; H04B 1/04

(57) ABSTRACT

Systems are configured to detect advanced fields, and are therefore able to provide instantaneous communications, radar detection, and remote telemetry. Receiving stations in communications systems and some telemetry systems communicate by modulating a variable termination resistor across the receiver's input terminals. Radar systems and some telemetry systems are sensitive to differential absorption at the targets.

### CROSS REFERENCE TO RELATED APPLICATIONS

This application claims the benefit of the following U.S. patent applications:
U.S. Provisional Patent Application No. 62/307/316, filed Mar. 11, 2016, for Instantaneous Communications Systems (inventors John M. J. Madey and Julius M. J. Madey); and
U.S. Provisional Patent Application No. 62/134,525, filed Mar. 17, 2015, for Instantaneous Communications Systems (inventors John M. J. Madey and Julius M. J. Madey).

The entire disclosures of the above mentioned applications and any attached or included materials are hereby incorporated by reference for all purposes.

### BACKGROUND OF THE INVENTION

The present invention relates generally to systems such as those used for signal communications, telemetry, feedback and control, and radar, and more particularly to such systems incorporating elements that manipulate and/or respond to advanced (converging) components of electromagnetic waves.

FIG. 1 is a high-level schematic showing a conventional communications system 10 based on the transmission and receipt of outgoing “retarded” (diverging) electromagnetic waves 15(ret) that dominate radiation in the world of everyday experience. The figure shows a transmitting station 20T and a receiving station 25R spaced by a distance d. The transmitting station is conventionally equipped with a transmitter 30, connected to a transmitting feedline 35(xmt), which in turn is coupled to a transmitting antenna 40(xmt). Electrical signals generated by the transmitter are fed up the transmitting feedline and excite the transmitting antenna, which launches electromagnetic waves 15(ret) into the air.

The receiving station is conventionally equipped with a receiver 45, connected to a receiving feedline 50(rcv), which in turn is coupled to a receiving antenna 55(rcv).

Electromagnetic waves incident on the receiving antenna generate electrical currents in the antenna, which are communicated down the receiving feedline to the receiver, which decodes or otherwise processes them. A fixed terminating resistor 60 (also referred to as a load resistor) is connected across the receiving feedline (i.e., between the receiver's input terminals).

In conventional receiver systems, the receiver's input impedance is typically adjusted to equal (“match”) the surge impedance of the feedline from the antenna to optimize the power coupled from the feedline to the receiver. Assuming that the electrical length of the feedline is an integral multiple of a half wavelength, the measured impedance of the feedline at the end closest to the receiver would equal the “feedpoint impedance” of the antenna. Thus, setting the receiver's input impedance equal to the impedance of the antenna/feedline system at the receiver would also optimize the power coupled from the antenna to the receiver.

When a pulse of radiation is launched by the transmitting station and directed to the receiving station, the pulse takes a time interval equal to d/c to reach the receiving station. The designation of one station as being the transmitting station and the other being the receiving station is for convenience since it is well known that many communications systems operate in both directions, and each station could be equipped to transmit and receive communications.

If in response to a received pulse, the receiving station launches a pulse of radiation back to the transmitting station, that pulse also takes a time interval equal to d/c to reach the transmitting station. Thus, round trip communications between the two sites will always be delayed by a minimum time interval equal to 2 d/c. For simplicity, only the forward communication link from transmitter to receiver is shown.

These same concepts are relevant to conventional radar systems where a transmitting radar station directs microwave energy toward a region that might contain a target, and a receiving radar station detects the power reflected from one or more targets in the region. The transmitting and receiving stations are typically the same location. Again, the distance of a target object is determined by the delay between sending the emitted pulse and receiving the reflected pulse. As above, this is 2 d/c, but in this case the measured delay 2 d/c is known, which allows the distance d to be determined.

### SUMMARY OF THE INVENTION

In short, embodiments of the invention manipulate and/or respond to advanced (converging) electromagnetic waves, which propagate towards the currents that generate those waves. The existence and properties of these advanced (converging) electromagnetic fields are consequences of Maxwell's equations, which are generally understood to govern all interactions between electrical charges and currents and the electric and magnetic fields they generate, including the interactions critical to the conservation of energy and momentum.

Analogous to the appearance of the advanced fields of the receiving station at the antenna of the transmitting station, embodiments of the present invention recognize and exploit the equality of (1) the time delay separating the emission of a pulse of radiation from the transmitting station's antenna and its receipt at the receiving station's antenna, and (2) the “lead time” separating the receiving station's advanced field's passage through the transmitting station's antenna and its arrival at the receiving station's antenna. This makes it possible to achieve the synchronized, instantaneous transmission of data between the transmitting and receiving sites.

Embodiments of the present invention can use physical devices that are present to some extent in all systems involving the transmission of signals via electromagnetic waves, and rely on the retarded fields generated by a transmitter. For example, passive devices such as directional couplers, hybrid couplers, coaxial cable delay lines, and phased dipole arrays are familiar from conventional microwave communication and remote sensing devices. However, embodiments modulate the terminating resistor (or equivalent tunnel diode) in the receiver to generate advanced fields, and provide specialized configurations of such devices at the transmitting station to detect the receiving station's weak advanced fields, while suppressing the much stronger retarded fields present in the vicinity of the transmitting station's antenna.

Embodiments of the present invention recognize and exploit the fact that the region of space within a wavelength or so of a compact radiating current distribution—the so-called “near field” or “near-field zone”—is characterized by spatial wavelengths that differ from the wavelength of the same radiation at greater distances from the current distribution. Specifically, the characteristic change in wavelength of the retarded fields in the near-field zones of transmitting antennas is attributable to the change of field profiles from the spherical Bessel functions in immediate proximity to the radiating elements of the transmitting antenna to the more familiar outgoing spherical waves at greater distances from the transmitting antenna.

Therefore, the transmitting station's antenna's retarded fields cannot interact with the fields from more distant sources to suppress by interference all the components of the advanced fields which pass through the near-field region. This makes possible to directly observe the amplitudes and phases of the advanced fields present in the near-field zone of a radiating charge or current distribution (e.g., an antenna). The effect was first described by Wheeler and Feynman (Wheeler 1945), who pointed out that the two fields become indistinguishable at greater distances from a radiating charge distribution in the far-field zone.

There are three methods for detection of the receiving station's advanced fields that can prove effective, either independently or in combination, to collect and detect the receiving station's advanced fields: (1) detection of the power deposited in the transmitting station's antenna by the receiving station's advanced fields as they pass the transmitting site, (2) interferometric suppression of the transmitting station's retarded fields based on the retarded fields' characteristic increased wavelength in the near field zone of the transmitting antenna, or (3) the interferometric suppression of the transmitting site's retarded fields based on the sign of their wave number (direction of propagation towards the receiving site.

According to an aspect of the invention, a communications system comprises a transmitting station and a receiving station separated by a distance that results in a particular time-of-flight interval.

The transmitting station comprises a transmitting-station antenna subsystem, a transmitting section, and a receiving section. The transmitting section comprises a transmitting-station transmitter, and a first transmitting-station feedline coupled to the transmitter at one end and to the transmitting-station antenna subsystem at the other end. The receiving section comprises a transmitting-station receiver, and a second transmitting-station feedline coupled to the transmitting-station antenna subsystem at one end and to the transmitting-station receiver at the other end.

The receiving station comprises a receiving-station antenna subsystem, a receiving-station feedline, a receiving-station receiver having input terminals, a variable terminating resistor across the receiving-station receiver's input terminals, and a mechanism for modulating the resistance of the terminating resistor with signal information to be communicated to the transmitting station.

Electrical signals generated by the transmitting-station transmitter are communicated along the first transmitting-station feedline to the transmitting-station antenna subsystem, which provides retarded radiation directed toward the receiving station. The retarded radiation directed toward the receiving station impinges on the receiving-station antenna subsystem and electrical signals are communicated on the receiving-station feedline to the receiving-station receiver.

The modulation of the load resister generates electrical signals in the receiving-station feedline, which are communicated to the receiving-station antenna subsystem, resulting in (a) a retarded wave propagating outward from the receiving station, and (b) a time-reversed advanced wave from infinity converging on the receiving station at the same time that the retarded wave diverges from the receiving station.

The advanced radiation converging on the receiving station reaches the transmitting station earlier than it reaches the receiving station by the particular time-of-flight interval, and) the advanced radiation received by the transmitting-station antenna subsystem is communicated along the second transmitting-station feedline to the transmitting-station receiver.

In some embodiments, the transmitting station comprises a directional coupler, the transmitting-station antenna subsystem uses the same antenna to send retarded radiation to the receiving station and to receive the advanced radiation, and the first and second transmitting-station feedlines share a common portion at the antenna and are separated into separate portions by the directional coupler with one portion being connected to the transmitting-station transmitter and one portion connected to the transmitting-station receiver.

In other embodiments, the transmitting-station antenna subsystem uses separate transmitting and receiving antennas to send retarded radiation to the receiving station and to receive the advanced radiation, and the first and second transmitting-station feedlines are separate feedlines. One is connected between the transmitting-station transmitting antenna and the transmitting-station transmitter, and the other is connected between the transmitting-station receiving antenna and the transmitting-station receiver.

In another aspect of the invention, there is provided a transmitting station for use in a communications system where the transmitting station sends retarded electromagnetic waves to a receiving station, and receives advanced and retarded electromagnetic waves from the receiving station. The transmitting station comprises a transmitting-station antenna subsystem, a transmitting section, and a receiving section.

The transmitting section comprises a transmitting-station transmitter, and a first transmitting-station feedline coupled to the transmitting-station transmitter at one end and to the transmitting-station antenna subsystem at the other end. The receiving section comprises a transmitting-station receiver, and a second transmitting-station feedline coupled to the transmitting-station antenna subsystem at one end and to the transmitting-station receiver at the other end.

Electrical signals generated by the transmitting-station transmitter are communicated along the first transmitting-station feedline to the transmitting-station antenna subsystem, which provides retarded radiation directed toward the receiving station. Electrical signals generated by the advanced electromagnetic waves from the receiving station are communicated along the second transmitting-station feedline to the transmitting-station receiver. The signals resulting from the received electromagnetic advanced waves arrive at the same time as the signals from the transmitting-station transmitter are generated.

As above, in some embodiments, the transmitting section and the receiving section share components, and in other embodiments, they have separate antennas and feedlines.

In another aspect of the invention, there is provided a receiving station for use in a communications system where a receiving station receives retarded electromagnetic waves from the transmitting receiving station, and sends advanced and retarded electromagnetic waves to the transmitting station.

The receiving station comprises a receiving-station antenna subsystem, a receiving-station receiver having input terminals, a variable terminating resistor across the receiving-station receiver's input terminals, a receiving-station feedline coupled to the receiving-station antenna subsystem and the receiving-station receiver, and a mechanism for modulating the resistance of the terminating resistor with signal information to be communicated to the transmitting station.

The modulation of the resistance of the terminating resistor generates signals in the receiving-station feedline, which are communicated to the receiving-station antenna subsystem, resulting in (a) a retarded wave propagating outward from the receiving station, and (b) an advanced wave propagating inward from infinity to the receiving station. The retarded and advanced waves are time-reversed versions of each other so that the advanced wave converges on the receiving station at the same time that the retarded wave diverges from the receiving station.

In an embodiment of the present invention, the variable resistor is comprises a PIN diode, and the mechanism for modulating the resistance of the terminating resistor comprises a junction field-effect transistor.

Embodiments of the invention are useful for radar and remote telemetry applications. Due to their also being configured to detect advanced fields, they are also characterized by instantaneous response.

A further understanding of the nature and advantages of the present invention may be realized by reference to the remaining portions of the specification and the drawings, which are intended to be exemplary and not limiting.

### BRIEF DESCRIPTION OF THE DRAWINGS

FIG. 1 is a high-level schematic showing a conventional communications system where a transmitting station launches retarded (diverging) electromagnetic waves towards a receiving station;

FIGS. 2-6 are schematics showing communications systems (that can also be used for remote telemetry) according to differing embodiments of the present invention where a transmitting station directs retarded (diverging) electromagnetic waves towards a receiving station, but also receives and detects the advanced (converging) electromagnetic waves generated by the receiving station;

FIG. 2 is a schematic of an embodiment where the transmitting station includes separate transmitting and receiving elements positioned and electrically connected in a phased-array configuration to provide high isolation between the transmitted retarded fields and the advanced and retarded received fields;

FIG. 3 is a high-level schematic of an embodiment that uses a directional coupler to allow the transmitting station's receiving antenna and receiving feedline to be shared with the transmitting station's transmitting antenna and transmitting feedline;

FIGS. 4 and 5 are schematics showing different implementations of the embodiment of FIG. 3;

FIG. 6 is a is a schematic of an embodiment where the transmitting station uses two dipole antennas, two directional couplers, and two hybrid couplers to achieve improved isolation, directional reception, and directional transmission;

FIG. 7 is a schematic showing one specific implementation of receiving station circuitry; and

FIG. 8 is a schematic of an embodiment of a radar system (that can also be used for remote telemetry).

### DESCRIPTION OF SPECIFIC EMBODIMENTS

### Overview of Invention

### Terminology

Antenna. A system of conductors which may be in the form of wires, rods, tubes, screens, or plates designed to accomplish the dual purposes of (1) optimizing the electromagnetic power exchanged between transmitting and receiving sites and (2) minimizing the electromagnetic power coupled to the input terminals of the receivers at the transmitting and receiving sites from other potentially interfering sources of radiation through the use of interferometry and/or shielding to block or cancel the interfering fields.

Near-field and far-field. The regions in space surrounding a radiating object (e.g., an antenna) are said to be characterized as part of the near-field zone or the far-field zone, as defined by the distance from the radiating object. There does not seem to be any agreed-upon definition of the distance at which the transition occurs, and there are also considered to be transition regions between these zones. For example, one Wikipedia entry shows the near-field zone divided into reactive and radiation sub-regions, followed by a transition zone, followed by the far-field zone.

Wavelength. Electromagnetic radiation can be characterized by a single frequency, but typically has different wavelengths over the different portions of it journey. For example, a radiating dipole antenna has different near-field and far-field wavelengths, with the near-field wavelength being longer than the far-field wavelength. When the radiation is traveling in a cable, it has yet a different wavelength, depending on the construction of the cable. Various descriptions of the transition between the near-field and far-field regions characterize distance from the radiating source in terms of the number of wavelengths. Since the near-field and far-field wavelengths differ, the only relatively unambiguous wavelength for these purposes would be the far-field wavelength given byfic.

In the context of this invention, these differences in wavelength make it possible to employ interferometric methods to selectively null either the advanced components of the fields attributable to the currents of a distant receiving antenna, or the retarded components of the fields attributable to a local transmitting antenna, when necessary to isolate these two components in communications or remote sensing systems.

Transmitter and receiver. These terms will normally be used to refer to circuits that are designed to transmit and receive (detect) signals. This is the normal use of the terms.

Transmitting station and receiving station. These terms will be used to differentiate two subsystems, each of which might include a transmitter and a receiver, and one or more antennas suitable for transmitting and receiving electromagnetic waves. These terms can also be used interchangeably with the terms “transmitting site” and “receiving site.”

Retarded and advanced fields/waves/radiation. The terms “retarded” and “advanced,” which are used to qualify the nouns fields, waves, and radiation, refer to two classes of electromagnetic fields that arise out of the symmetry of Maxwell's equations as described above. This will be will be discussed in detail below.

### Theoretical Background

While it has been understood for more than 100 years that the existence and properties of electromagnetic radiation follow from the provisions and constraints set forth in Maxwell's equations, the implementation of those provisions has been a matter of some controversy for almost as long a time. The primary issues here have been the assumptions adopted regarding the nature of time and the effect of those assumptions on our understanding of the interactions of localized, oscillating current distributions exemplified by the currents flowing in transmitting and receiving antennas and other radiating and absorbing current distributions.

In what must be one of the longest running misrepresentations of modern physics, it has as a consequence of our misunderstanding of the nature of time that the conservation of energy in these radiating systems must require a third basic electromagnetic force—the radiation reaction force—in addition to the electric and magnetic forces described in the Lorentz force equation. But the weight of experimental evidence has now clearly established that the resolution of this problem lies not in the hypothesis of a third basic electromagnetic force, but rather in the reformulation of electrodynamics as required for consistency with the time-symmetry implicit in Maxwell's equations.

The relevant evidence has been described by Niknejadi et al. (Niknejadi 2015) in a recent paper analyzing the inability of the present formulation of electrodynamics to satisfy energy conservation in the emission of the coherent radiation by two or more coherently oscillating charges. While it has long been the practice to assume that electromagnetic waves can only propagate in time from the past to the future, solutions to the field equations based on this assumption yield interactions in the near field zones of oscillating pairs of particles that are grossly incompatible with energy conservation. This flaw can only be corrected by reformulating the field equations to impose the time-symmetry inherent in Maxwell's equations in the Green's function that defines the allowable forms of the solutions for the electric and magnetic fields in these problems.

Although this revised version of electrodynamics presents no particular difficulties in terms of computation, it yields a number of remarkable new insights into the effects of time symmetry and the nature of the interactions between oscillating charge distributions. This includes an elementary explanation of the previously inexplicable instantaneous nature of the “radiation reaction force” in electrodynamics as well as the possible exploitation of these newly disclosed interactions in the development of novel new instantaneous communication, remote sensing, and radar systems in accordance with embodiments of the present invention. Set forth below are the mechanisms by which these newly discovered effects can be applied to realize the practical construction and operation of these new systems.

The relationship between the electric and magnetic fields emitted by oscillating charge distributions in the course of radiation is most frequently analyzed by solution of the inhomogeneous wave equation in the frequency domain. Given the second order derivatives of these fields with respect to time in the time domain, the solutions for the radiation fields in the frequency domain include both positive and negative values of the wave number k(k=ω/c) where positive values of k are associated with wave propagation diverging towards infinity from the position of the oscillating charges, and negative values of k with wave propagation converging from infinity towards the positions of the oscillating charges. The paired solutions (positive and negative k) physically constitute time-reversed versions of each other and are usually referred to as the “retarded” and “advanced” solutions to the inhomogeneous wave equation.

Electromagnetic waves converging from infinity towards an oscillating charge distribution had never been observed at the time the roles of these two solutions first became a matter of discussion. Therefore, it was concluded by Arnold Sommerfeld and others (but not Einstein) that the advanced fields predicted by Maxwell's Equations were not physically realistic and should be discarded as artifacts, thereby setting the pattern for solution of the wave equation for the next 100 years.

But Sommerfeld's recommendation ignored an alternative approach that did not require any ad hoc decisions regarding the nature of time in the universe in which we live, only acknowledgment of the fundamental symmetry inherent in Maxwell's equations regarding the direction of time. And that objective can be achieved simply by modifying the Green's function for solution of the inhomogeneous wave equation to include equal contributions from the positive and negative k solutions for the waves created by all oscillating charges. In this way, the obvious asymmetries with respect to time in the world in which we live could be explained by the obvious temporal asymmetry of other basic physical processes like thermodynamics or dissipation without neglecting the fundamental time symmetry of electrodynamics.

This elementary change in the formal solutions to the inhomogeneous wave equation has revolutionized our understanding of the interactions of oscillating charges and currents at all scales and in all applications. In particular, the radiation of power by oscillating charges or currents is now quantitatively seen to occur as part of the interactions of the radiating charges with the distant charge distributions whose dynamics include some element of dissipation as first hypothesized by Wheeler and Feynman (Wheeler_1945): absent the introduction of dissipation, there is no radiation. Exact solutions to the time symmetric wave equation for these interacting charge distributions have also demonstrated the means by which radiating charges can interact instantaneously with distant charge distributions without violating causality, and the way in which the introduction of even small amounts of dissipation determine the direction of the “arrow of time” (Smith_2015),

In the systems described below, the interactions of a transmitting and receiving station are described in terms of their principal retarded and advanced fields in the time domain. This description is not capable of providing the same level of qualitative and quantitative detail as available from analysis in the frequency domain as outlined in the referenced publications and reports (Madey_2015, Niknejadi_2015, Smith_2015). However, a general description of operation in the time domain picture is more useful in identifying the interactions that enable the effectively instantaneous interactions that make possible the proposed instantaneous communications systems.

### Retarded and Advanced Fields/Waves/Radiation

The existence of these two classes of solutions to Maxwell's equations reflects at the most basic level the time-symmetry of Maxwell's equations. But they also serve the fundamental practical purpose of providing the means by which oscillating charge or current distributions can instantaneously exchange energy with other distant charge or current distributions to fulfill the requirements of energy conservation in the process of radiation.

In the context of the present invention, the existence of these two classes of solutions to Maxwell's equations also make it possible for a local transmitter to instantaneously exchange energy with a distant receiver providing for the instantaneous exchange of data through the modulation of the transmitted power and the load impedance of the receiving antenna. It is noted as a threshold matter that the retarded and advanced fields exist in free space and not in the transmitters, receivers, and feedlines that together with the antennas for these sites constitute the hardware that create these two components of the radiated electromagnetic fields, or convert these fields to the electrical currents that constitute the detected signals.

Retarded electrical fields are generated by the oscillating electrical currents that flow along the surfaces of the electrical conductors incorporated in the construction of the transmitting antennas, and propagate outwards towards infinity from these conductors. The corresponding advanced fields take the form of the time-reversed versions of these retarded fields, propagating in vacuum towards the conducting elements of these antennas with amplitudes determined by the boundary conditions relating surface current density to the amplitudes and phases of the converging waves.

Each of the two types of fields plays a critical role in the conservation of energy and momentum in the interaction of spatially separated localized oscillating current distributions. For a single such oscillating current distribution, the electric and magnetic components of the radiated field differ in phase by 90 degrees, yielding a Poynting's vector that has no real component. The surface integral of such a Poynting's vector is thus purely imaginary, indicating that the fields radiated by such a isolated current distribution carries no radiated power.

However, these fields can excite currents on the surfaces of the elements of distant receiving antennas. Further, if the elements of such a receiving antenna are connected through a resistive element with either real positive resistance (e.g., two-terminal metal-film resistor) or negative resistance (e.g., tunnel diode), the voltage between these elements will oscillate with the same phase as the current (from Ohm's law, V=IR), generating radiated advanced and retarded fields in which the electric and magnetic fields have the same phase and hence carry real—not reactive—power.

The retarded field components radiated by such a receiving antenna propagate outwards in time from the receiving antenna to the transmitting antenna, and hence do not arrive at the transmitting antenna for an interval of time d/c where d is the distance between the two antennas. However, the advanced fields generated by the currents that flow in the receiving antenna propagate towards the transmitting antenna, arriving at the transmitting antenna an interval of time d/c before the receiving antenna is illuminated by the transmitting antennas retarded field components. The advanced fields of the receiving antenna therefore illuminate the transmitting antenna at the same time the transmitting antenna is “excited” by the EMF that created the oscillating current distribution that initiated its emission of radiation.

However, while the voltage and current initially excited by the transmitter's EMF were 90 degrees out of phase, there are now additional currents flowing in the elements of the transmitting antenna due to the advanced fields of the receiving antenna, leading to the extraction of real power from the transmitter's EMF for the purpose of energy conservation. Further, given the directions and velocities of the advanced and retarded fields in the system, the power absorbed by the receiving antenna is drawn from the transmitting antenna at the same time as the initial pulse of radiation is emitted by the transmitting antenna. In this way, the energies radiated and absorbed in the two antennas of the system appear to be exchanged without delay at each of the antennas, even though the times of those exchanges are separated by the interval d/c.

### Communications Systems Using Advanced Fields (Advanced-Field Communications Systems)

The techniques according to embodiments of the present invention provide transmission of data that, for the operator of the transmitting station, is equivalent in all respects to the instantaneous exchange of data without the propagation delay d/c characteristic of communications systems that rely solely on the transmitter's retarded fields. This is done by combining the modulation of the transmitter's radiated power through modulation of its EMF with the possibility of modulating the terminating resistance of the receiving antenna.

What is needed for such a system, and what is provided by embodiments of the present invention, are techniques for selectively detecting the receiving antenna's advanced field components at the position of the transmitting antenna during the time that the transmitting antenna is being driven by its transmitter/EMF. The examples below show four embodiments through which this can be accomplished.

### Some Technology Considerations

These basic considerations can be exploited to develop systems capable of achieving the instantaneous exchange of data between distant transmitting and receiving stations through the development of techniques to (1) detect the presence and waveform of the advanced fields radiated by the receiving station when irradiated by the retarded fields of the transmitting station, and (2) to modulate the advanced fields of the receiving station as required to encode the data to be forwarded to the transmitting station

The technology available to design and implement these novel solution is generally straightforward except for the issues raised by spatial and temporal overlap of the receiver's advanced fields with the retarded fields of the transmitter, and the generic differences in amplitude between these two fields.

Since the receiver's advanced fields are simply the time reversed images of its more familiar retarded fields, signal amplitude is generally not the limiting factor in the detection of these advanced fields. The more fundamental problem is the effect identified by Wheeler and Feynman (Wheeler 1945) in which the interference of the advanced fields attributable to the multiple absorbing objects in the vicinity of the receiving station yield a composite field in the far field zone of the transmitting antenna in which the composite advanced field of all the absorbing objects cannot be distinguished from the transmitter's retarded field.

The only volume of space in which the advanced fields of the receiving station and other nearby absorbers can be distinguished from the retarded fields of the transmitting station is the region within the near-field zone of the transmitting antenna. Within that volume the physics determining the form of the transmitter's retarded outgoing waves force those waves to assume a distinct geometric form (spherical Bessel functions) that are characterized by wavelengths that diverge from the free space wavelength of outgoing retarded waves, and are thus incapable of interfering with the advanced waves of the receiving station. Waves with these differing geometric forms can not be made to cancel each other through interference

The receiving station's advanced fields also typically propagate within the antenna system for the transmitting station in directions which differ from the transmitter's outgoing retarded waves making possible the use of direction-sensitive devices like directional couplers to isolate the two waves.

The amplitude of the receiving station's advanced fields at the transmitting antenna can also be optimized by several means to enhance the system's signal to noise ratio. Since the receiving station's advanced fields serve, amongst other purposes, the extraction of energy from the EMF in the transmitting station that provides the oscillating current needed to excite the oscillating currents on the elements of the transmitting antenna that generate the antenna's retarded fields, any steps taken to optimize the power directed towards the receiving station will increase the receiving station's advanced fields and also the currents flowing on the elements of the transmitting antenna as required to extract additional power from the transmitter's EMF making the advanced fields easier to detect.

Given that the usual way to increase the power directed by a transmitting station towards a receiving station is to improve the directivity of the transmitting antenna, this measure has the additional effect of reducing the fields of potentially interfering absorbing objects in the vicinity of the receiving antenna.

While no distinctions can be drawn regarding the signals that appear in the past and the future in the frequency domain, the analytic theory for radiation in the frequency domain includes a proof that no radiation can occur in the frequency domain absent the coupling of the currents that flow in the transmitting and receiving antennas of a communications system by the retarded and advanced fields of the two subsystems' antennas.

In particular, each of the antennas in such a system, when isolated from interactions with the complementary antenna, represents a purely reactive load on which the current at the feedpoint is 90 degrees out of phase with the voltage across the feedpoint attributable to the EMFs that drive the two antennas. But when the two antennas are allowed to interact via their combined retarded and advanced fields, the current through the terminating resistor of the designated “receiving antenna” must flow in phase with the voltage across the resistor according to Ohm's law V=IR.

That current in the elements of the receiving antenna then generates advanced and retarded fields that are in phase with the voltage across the terminating resistor resulting in the absorption of power from the fields of the transmitting antenna and the appearance of an in-phase component of current through the EMF driving the transmitting antenna. It thus follows that the introduction of a real component of impedance in the terminating resistance of the receiving antenna provides both for the transmission of power between transmitting and receiving antenna and also the means required to conserve energy at the feedpoints of both the transmitting and receiving antennas. It is this mechanism that also provides for the modulation of the current flowing between the terminals of the feedpoint for the transmitting antenna by variation of the terminating resistor for the receiving antenna.

### Overview of Embodiments

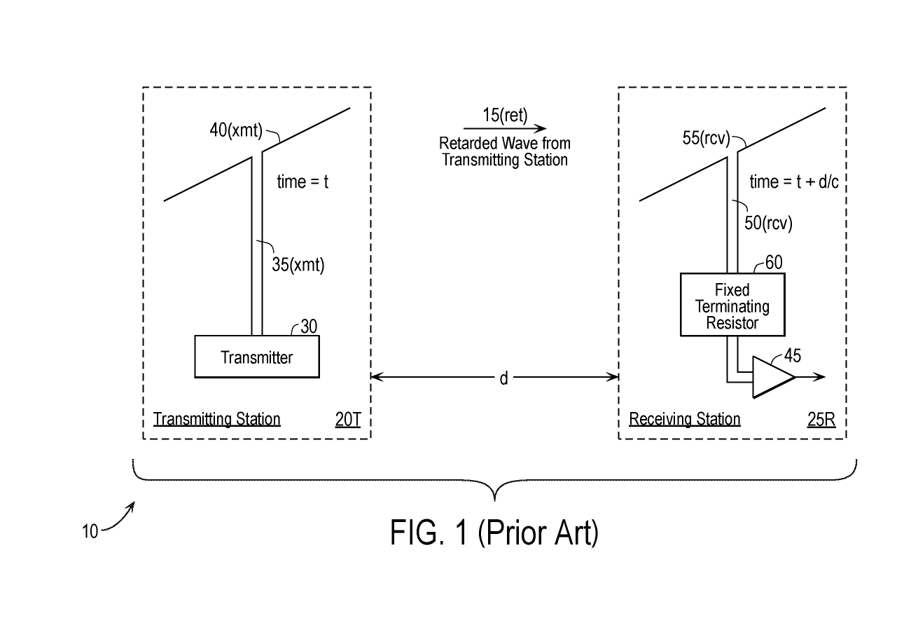

In the illustrations below, the transmitting station will be shown as transmitting electromagnetic waves to the right to a receiving station. With this convention, the transmitting station sends retarded electromagnetic radiation to the right, and advanced electromagnetic radiation approaches the receiving station from the left. Both the outgoing retarded radiation and the incoming advanced radiation will be traveling from left to right. As in the case of the conventional system of FIG. 1, the transmitting station and the receiving station are spaced by a distance d. As discussed below, some embodiments directly measure the incoming advanced radiation, while other embodiments measure the advanced fields in other ways.

The advanced fields manifest themselves in two ways. First, when a distant object, such as a receiving antenna, absorbs radiation launched by the transmitting antenna, it immediately and automatically launches retarded and advanced fields. The retarded field diverges from the receiving antenna while the advanced field simultaneously converges from infinity on the receiving antenna. For energy conservation, the advanced field also acts to simultaneously increase the output power at the transmitting antenna. The retarded and advanced fields are time-reversed versions of each other.

Some embodiments are designed to directly capture some of the advanced component of the fields generated by the receiving antenna in the near field region of the transmitting antenna. That is, the transmitting station has one or more antennas that can selectively isolate the incoming advanced waves.

Other embodiments are designed to detect the currents in the transmitting antenna's feedline that reflect the advanced field's need to make sure that energy is conserved at the transmitting station. These embodiments use a directional coupler to extract the signal attributable to the receiving station's advanced field. That is, these embodiments exploit the role played by the receiving station's advanced fields in energy conservation. As discussed above, the reason the currents due to the receiving station's advanced fields are present on the feedline to the transmitter is to increase the product of i*v (or E*J) at the output of the transmitter, thereby extracting a small amount of additional power (equal to the power absorbed by the receiving antenna) from the transmitter.

In alternative embodiments of the invention employing planar, cylindrical, spherical, or parabolic reflectors as part of their antenna systems, the direction of the advanced fields passing through the transmitting antenna system will be altered by reflection from these surfaces.

The transmitting station should be seen as including a transmitting section and a receiving section. The transmitting section includes a transmitter, a transmitting feedline, and a transmitting antenna for sending the retarded radiation to the receiving station. The receiving section includes a receiving antenna for capturing the retarded radiation, a receiver, and a receiving feedline for communicating an electrical signal representing the advanced radiation to the receiver. In some embodiments, the transmitting section and the receiving section have separate feedlines and antennas. In other embodiments, the transmitting section and the receiving section share elements (e.g., use the same antenna or antennas, and have partially coincident transmitting and receiving feedlines).

The different embodiments will typically include some corresponding elements, and the same reference numeral will be used across embodiments, but suffixed with one or more primes (′) to denote the different embodiments.

### FIRST EMBODIMENT

### Separate Antennas and Feedlines

### System Configuration

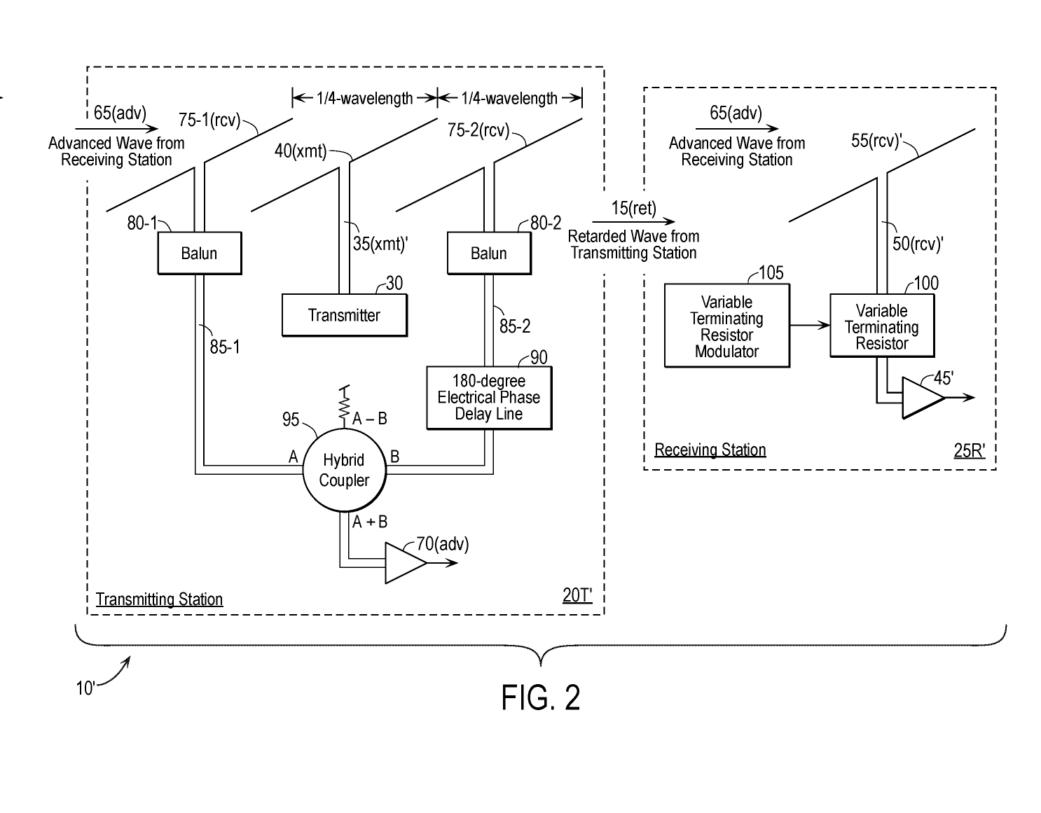

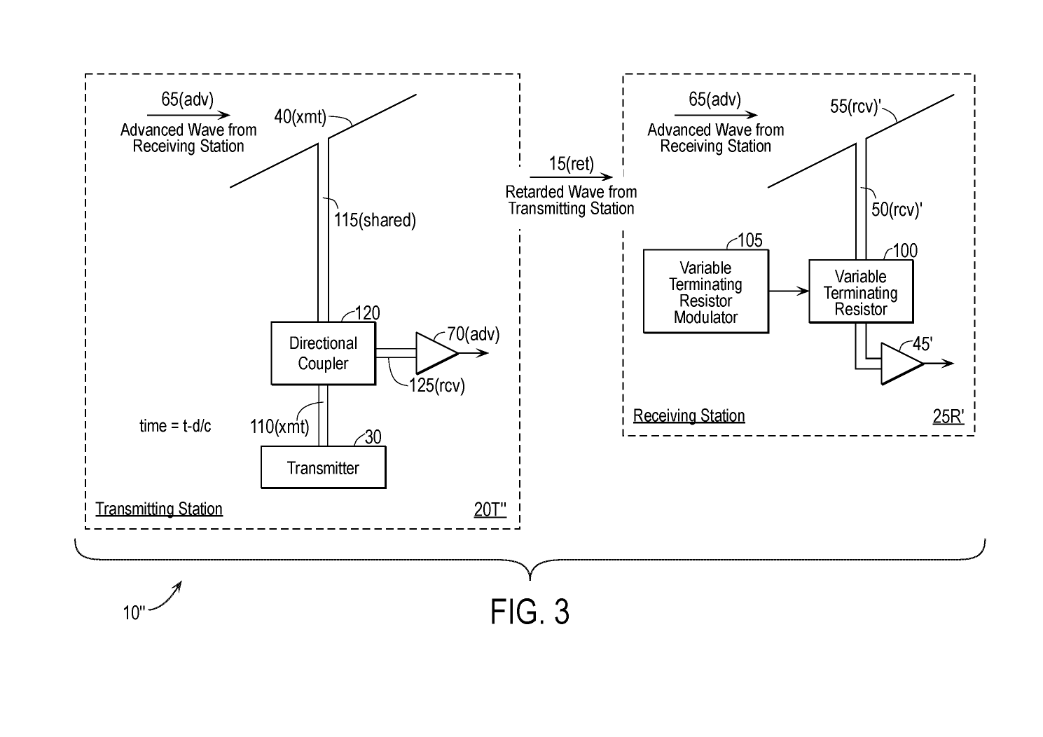

FIG. 2 is a schematic showing a communications system 10′ in an embodiment of the present invention where a transmitting station 20T′ sends retarded (diverging) electromagnetic waves 15(ret) to a receiving station 25R′, but also receives and detects advanced (converging) electromagnetic waves 65(adv) from the receiving station. Transmitting station 20T′ and receiving station 25R′ are modified relative to the system shown in FIG. 1 to support advanced-field communications, as will now be described.

This embodiment, as well as some other embodiments, make use of hybrid couplers. A hybrid coupler is a four-port device, two input ports and two output ports. One of the output ports provides the sum of the signals at the two input ports and the other provides the difference. In this application, the input ports will be referred to as the A and B ports, and the output ports will be referred to as the A+B port and the A-B port.

In this embodiment, transmitting station 20T′ includes separate transmitting and receiving sections. That is, the receiving antenna and receiving feedline are separate from the transmitting antenna and transmitting feedline. In this embodiment and the communications system embodiments described below, the transmitting station includes a receiver 70(adv).

The transmitting section includes the conventional elements of the transmitting station shown in FIG. 1, namely transmitter 30, connected to transmitting feedline 35(xmt), connected to transmitting antenna 40(xmt). The transmitting antenna is shown as a dipole antenna. The receiving section includes a receiving antenna that is implemented as first and second dipole antennas 75-1(rcv) and 75-2(rcv) located on the left and right sides of transmitting antenna 40(xmt)′.

First and second receiving dipole antennas 75-1(rcv) and 75-2(rcv) are connected through respective baluns 80-1 and 80-2 to respective first and second coaxial cable segments 85-1 and 85-2. First and second dipole antennas 75-1(rcv) and 75-2(rcv) are spaced from transmitting antenna 40(xmt) by ¼ of the far-field wavelength, and coaxial cable segment 85-2 is provided with a delay line 90 that provides a 180-degree electrical delay in the phase of the transmitted signal. The receiving section also includes a hybrid coupler 95. Equal-length coaxial cable segments 85-1 and 85-2 are connected to the A and B ports of hybrid coupler 95, receiver 70(adv) is connected to the A+B port, and the A−B port is terminated.

The equal spacing of receiving dipole antennas 75-1(rcv) and 75-2(rcv) from each other, and the extra 180-degree electrical delay in coaxial cable segment 85-2, operate to prevent radiation emitted from transmitting antenna 40(xmt)′ from reaching receiver 70(adv). Since the receiving dipole antennas are equally spaced from the transmitting antenna, the signal reaching the A port of hybrid coupler 95 is 180 degrees ahead in phase of the signal reaching the B port. Therefore, the signals cancel when communicated to the A+B port (the signals would reinforce at the A−B port, but that output is dumped in the termination).

On the other hand, advanced waves coming from the left are constructively reinforced since the ½-wavelength delay between first and second dipole antennas 75-1(rcv) and 75-2(rcv) and the 180-degree electrical delay results in the signals arriving at the A and B ports of hybrid coupler 95 being in phase. The incoming retarded wave from the right would also be constructively reinforced in this manner.

Thus it can be seen that the three dipoles cooperate as a phased-array transmitting/receiving system that provides high isolation between the transmitted retarded signals and the advanced/retarded received signals. This system, however, does not provide directivity of the transmitted retarded waves since both are constructively reinforced.

Receiving station 25R′ includes an antenna 55(rcv)′, which is used for sending and receiving signals, a receiving feedline 50(rcv)′, and a receiver 45′ with a variable terminating resistor 100 connected across the receiving feedline (i.e., between the receiver's input terminals). The receiving station does not use a separate transmitter to send advanced waves. Rather, the receiving station includes a modulation circuit 105 coupled to variable terminating resistor 100 and is controlled to modulate the resistance of terminating resistor 100 in accordance with a desired signal pattern.

In this and other embodiments of the invention, the modulated “terminating resistor” at the receiver end of the antenna/feedline system serves an additional purpose: altering the current flowing in the elements of antenna 55(rcv)′ by varying the resistance through which the EMF (electromotive force) present at the feedpoint and attributable to the reception of the transmitter's retarded fields must flow. Alterations in the current flowing in the elements of the antenna by this means changes both the receiving antenna's advanced and retarded fields, permitting the modulation of the currents induced in the transmitting antenna system by the advanced fields of the receiving antenna.

### System Operation

For convenience since the context is clear, antenna 40(xmt)′ of transmitting station 20T′ will be referred to as the “transmitting antenna,” and antenna 55(rcv)′ of receiving station 25R′ will be referred to as the “receiving antenna.”

The “time symmetric” formulation of electrodynamics results in the excitation by radiating charge distributions of equal amplitude outgoing “retarded” waves and converging “advanced waves, both of which define the nature of a charge distribution's interaction with the electromagnetic field. Thus the excitation of the currents in receiving antenna 55(rcv)′ by the outgoing retarded component of the fields of transmitting antenna 40(xmt)′ must be accompanied by the appearance of a converging advanced component of the receiving antenna's fields, which arrives at receiving antenna at the same time as the transmitting antenna's outgoing retarded field arrives at receiving antenna.

And to get to the receiving antenna at that time, the receiving antenna's converging advanced wave had to pass through the transmitting antenna at a time d/c before the time the transmitting antenna's outgoing retarded wave appeared at the receiving antenna. This fundamental requirement establishes that the advanced field of the currents excited in the receiving antenna by the transmitted pulse must overlap with the transmitted pulse at the transmitting antenna at the time of emission.

A first point to note is that this component of the advanced field of the currents in the receiving antenna will excite a signal in the nearfield of antenna 40(xmt)′ that will be detected by receiving dipole antennas 75-1(rcv) and 75-2(rcv) and propagate down the receiving feedlines towards the A and B ports of hybrid coupler 95 and to receiver 70(adv) at the transmitting station.

A second point to note is that the operator of the receiving site 25R′ can encode data in the currents excited in the receiving antenna by the incoming retarded pulse from the transmitting antenna by changing the impedance of the load at the feedpoint of the receiving antenna that determines the ratio of the voltage to the current passing through the terminating resistor and the elements of the receiving antenna.

That induced change in the currents in the receiving antenna must modulate the amplitude of the receiving antenna's converging advanced wave, and hence the signal traveling down the receiving feedlines at the transmitting site, towards the A and B ports of hybrid coupler 95 and to receiver 70(adv).

In principle, both operators could simultaneously transmit their data by modulation of the currents in their respective antennas, though it would likely be easier to decode that data at the transmitting antenna if the operator of the receiving site waited for a quiescent interval in the modulation of the transmitting site's signal to enter the data in a way reminiscent of the timing of transmissions that serve as the basis of the Ethernet.

### SECOND EMBODIMENT

Shared Antenna with Directional Coupler in Feedline

### System Configuration

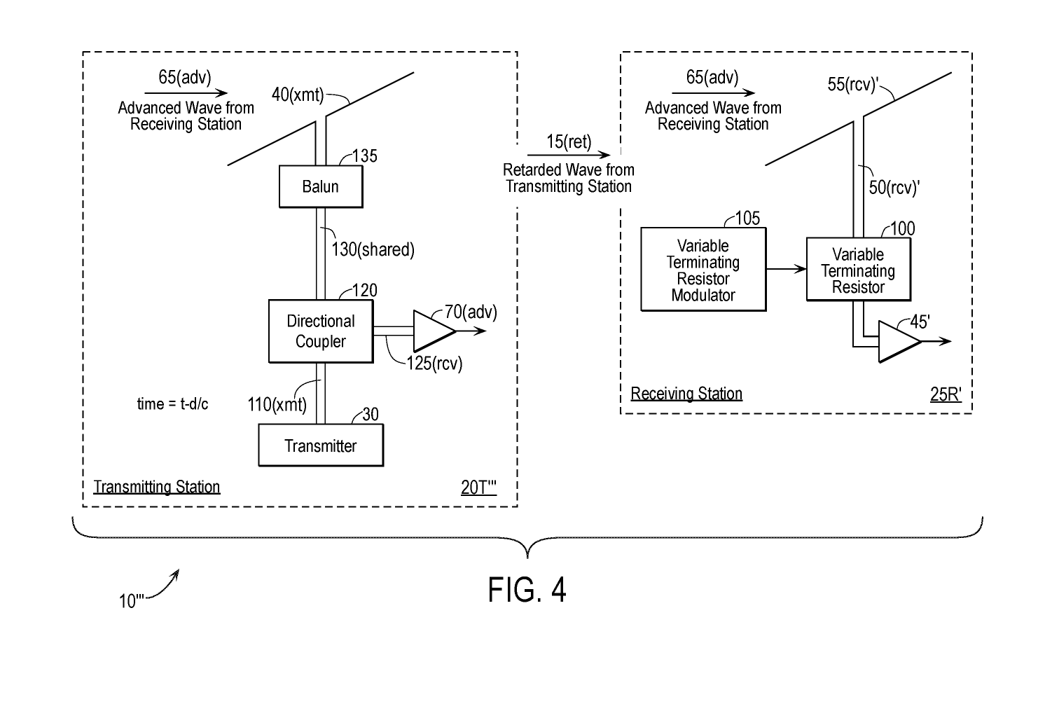

FIG. 3 is a high-level schematic showing a communications system 10″ in another embodiment of the present invention. This embodiment is one of a class of systems where the transmitting section and the receiving section of transmitting station 20T″ share elements.

Transmitting station 20T″ includes a transmitter 30 connected to a transmitting feedline segment 110(xmt) and a shared feedline segment 115(shared), which in turn is connected to a transmitting antenna 40(xmt). Electrical signals generated by the transmitter are fed up the transmitting and shared feedline segments and excite the antenna, which launches the electromagnetic waves into the air. The retarded component is directed to receiving station 25R′.

In this embodiment, antenna 40(xmt) is also configured to receive incoming advanced radiation. A directional coupler 120 is interposed between shared feedline segment 115(shared) and transmitting feedline segment 110(xmt). A portion of the signals traveling down the shared feedline segment exit the coupled port and are sent via a receiving feedline segment 125(rcv) to receiver 70(adv).

Transmitting feedline segment 110(xmt) and shared feedline segment 115(shared) together define a transmitting feedline. Similarly, shared feedline segment 115(shared) and receiving feedline segment 125(rcv) together define a receiving feedline.

In this embodiment, the retarded component 15(ret) of the radiation emitted by transmitting antenna 40(xmt) propagates towards receiving station 25R″ while transmitting antenna 40(xmt) simultaneously interacts with the advanced component 65(adv) of the radiation generated by the currents excited by the transmitter's retarded fields 15(ret) in the receiving antenna.

### Additional Details and Variations

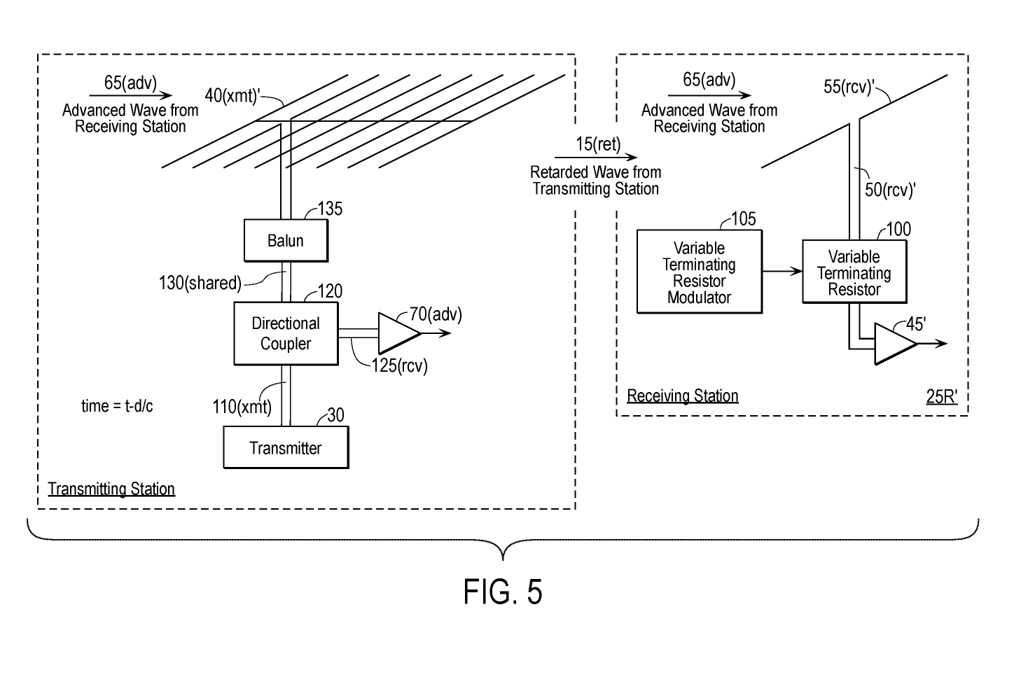

FIG. 4 is a schematic showing a communications system 10″′ in another embodiment of the present invention where a transmitting station 20T″′ sends retarded (diverging) electromagnetic waves 15(ret) to a receiving station 25R′. Like the other embodiments, transmitting station 20T″′ includes a transmitter 30 and a receiver 70(adv). This embodiment shows one possible implementation of the system of FIG. 3. As in FIG. 3, antenna 40(xmt), shown as a dipole antenna, is also configured to receive incoming advanced radiation.

Transmitter 30 is connected to a transmitting feedline segment 110(xmt), which is connected via the straight-through ports of a directional coupler 120 to a shared feedline segment 130(shared), which is connected to antenna 40(xmt) through a balun 135. The coupled port of directional coupler 120 is connected through receiving feedline segment 125(rcv) to receiver 70(adv) to direct signals from the antenna to the receiver.

FIG. 5 shows a system similar that of FIG. 4 except that the transmitting station's antenna is a Yagi antenna, which provides directivity of the transmission to the receiving station.

In both these implementations, the structure and operation of the receiving stations are basically the same as in the cases shown in FIGS. 2 and 3.

### System Operation

The system operation is similar to that described above in connection with FIG. 2, with only the differences noted here.

A first point to note is that this component of the advanced field of the currents in the receiving antenna will excite a signal in the transmitting antenna that will propagate down the receiving feedline for the transmitting antenna towards the transmitter and can be detected by means of directional coupler 120 in the feedline that captures and directs that incoming signal through its coupled port to receiver 70(adv) at the transmitting station. It is this component of the receiving station's advanced fields that modifies the current drawn from the transmitter's RF power source to achieve net energy conservation.

A second point to note is that the operator of the receiving site 25R′ can encode data in the currents excited in the receiving antenna by the incoming retarded pulse from the transmitting antenna by changing the impedance of the load at the feedpoint of the receiving antenna that determines the ratio of the voltage to the current passing through the terminating resistor and the elements of the receiving antenna.

That induced change in the currents in the receiving antenna must modulate the amplitude of the receiving antenna's converging advanced wave, and hence the signal traveling down shared feedline segment 115(shared), exiting the coupled port of directional coupler 120, and down feedline segment 125(rcv) to receiver 70(adv) at the transmitting site.

### THIRD EMBODIMENT

### Phased Array Antenna

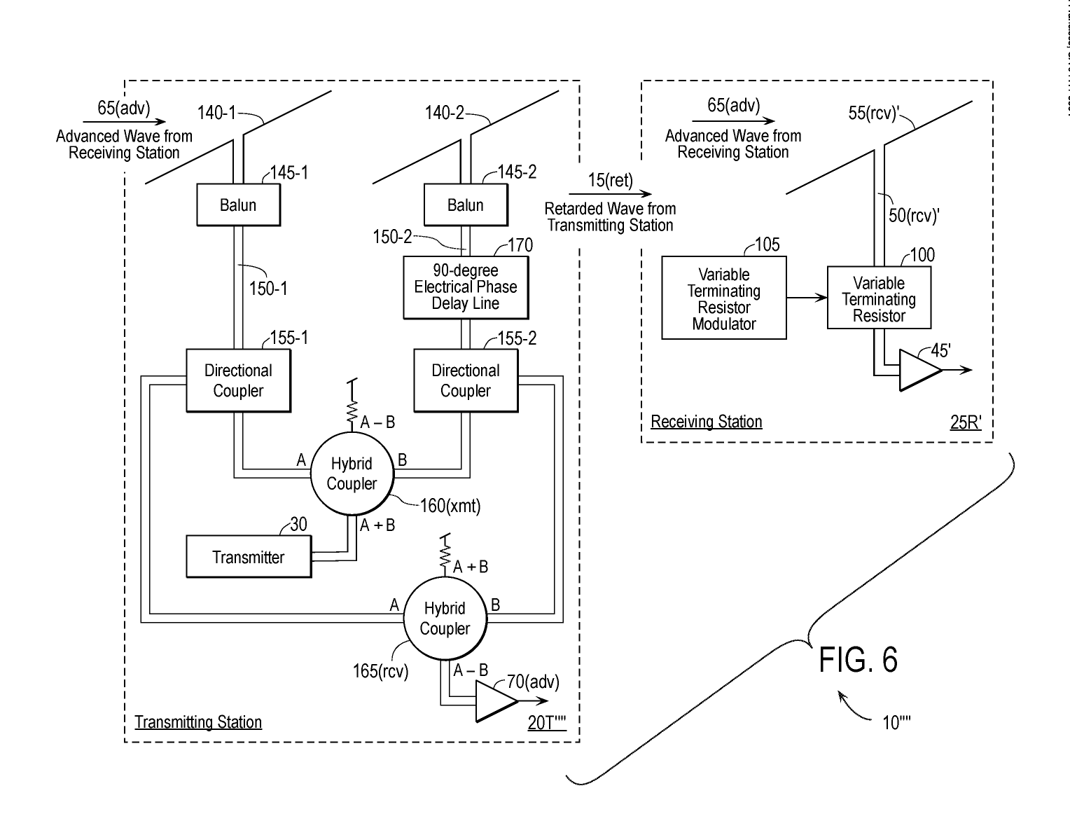

FIG. 6 is a schematic showing a communications system 10″″ in another embodiment of the present invention where the transmitting station uses two directional couplers and two hybrid couplers to provide directional transmission and directional reception as well as isolation of the transmitted and received signals. Like the other embodiments, transmitting station 20T″″ includes a transmitter 30 and a receiver 70(adv). This embodiment uses first and second dipole antennas 140-1 and 140-2 of a phased-array antenna, both of which are used for transmitting retarded waves to a receiving station and receiving advanced waves from receiving station 25R′. Dipole antennas 140-1 and 140-2 are connected through respective baluns 145-1 and 140-2 to respective first and second coaxial feedline segments 150-1 and 150-2.

The coaxial feedline segments are connected to in-line ports of respective first and second directional couplers 155-1 and 155-2, the other in-line ports of which are connected to the A and B ports of a transmitting hybrid coupler 160(xmt). The A+B port of transmitting hybrid coupler 160(xmt) is connected to transmitter 30, and the A−B port is terminated. The coupled ports of directional couplers 155-1 and 155-2 are connected to the A and B ports of a receiving hybrid coupler 165(rcv). The A−B port of receiving hybrid coupler 165(rcv) is connected to receiver 70(adv) and the A+B port is terminated.

Second dipole antenna 140-2 is spaced ¼ of the far-field wavelength to the right of first dipole antenna 140-1 and second coaxial feedline segment 150-2 is provided with a delay line 170 that provides a 90-degree electrical delay. Accordingly, signals from advanced waves coming in from the left are 180 degrees out of phase when they reach the A and B ports of transmitting hybrid coupler 160(xmt) and receiving hybrid coupler 165(rcv). They constructively interfere at receiving hybrid coupler 165(rcv) since they are subtracted, while they destructively interfere at transmitting hybrid coupler 160(xmt) since they are added.

Thus it can be seen that the elements of the transmitting section, namely the two spaced dipole antennas 140-1 and 140-2, their feedlines, 90-degree delay line 170, and transmitting hybrid coupler 160(xmt) are configured to employ constructive interference to augment the power radiated in the direction of the remote receiving station while employing destructive interference to suppress the power radiated in the opposite direction.

The elements of the receiving section, namely the same two dipoles and their feedlines, directional couplers 155-1 and 155-2 that selectively outcouple the power coupled to the dipoles from the remote receiving station's advanced fields, the subsequent feedlines to receiving hybrid coupler 165(rcv), which hybrid coupler takes the difference between the signals on the two receiver feedlines, serves the primary purpose of receiving the advanced signals coming in from the left. The receiving section also serves the following three purposes:
(1) It uses constructive interference to enhance the sensitivity to the advanced fields of the remote receiving antenna. As mentioned above, waves/signals coming from the left, when they exit the two directional couplers' coupled ports, are out of phase and are subtracted at hybrid coupler 160(rcv), thus being reinforced.
(2) It uses destructive interference to suppress the signals attributable to the receiving antenna's retarded fields. Waves/signals coming in from the right, when they exit the directional couplers' coupled ports, are in phase and are subtracted at hybrid coupler 160(rcv), thus being canceled.
(3) It uses destructive interference to cancel the strong signals that would appear at the receiver due to the fields generated by the currents driven in the two dipoles by the transmitter.

More specifically, with respect to the last item, the receiving section uses destructive interference to cancel signals from the transmitter resulting from waves launched from one dipole being picked up by the other.

Signals from hybrid coupler 160(xmt)'s A port, which are launched as waves by dipole antenna 140-1, encounter a ¼-wavelength delay before picked up by dipole antenna 140-2, and the resulting signals encounter a 90-degree delay before reaching hybrid coupler 160(rcv)'s B port.

Similarly, signals from hybrid coupler 160(xmt)'s B port, encounter a 90-degree delay before being launched as waves by dipole antenna 140-2, the waves encounter a ¼-wavelength delay before picked up by dipole antenna 140-1, and the resulting signals reach hybrid coupler 160(rcv)'s B port.

Thus, the signals resulting from waves from dipole antenna 140-1 and picked up by dipole antenna 140-2, are in phase with signals resulting from waves from dipole antenna 140-2 and picked up by dipole antenna 140-1, and are subtracted at hybrid coupler 160(rcv), thus being canceled.

### Design Trade-Offs

The embodiments of FIGS. 2 and 6 are based on the phased-array principle, using interference to suppress the currents in the receiving dipoles induced by the much stronger near field transmitting antenna. The three-dipole embodiment of FIG. 2 is the simpler of the two, and can achieve very high rejection ratios by adjusting the spacing of the three dipoles with a micrometer screw. But this three-antenna system is incapable of providing any directivity for either the central transmitting antenna or the two outboard receiving antennas.

The two-dipole embodiment of FIG. 6 is capable in principle of directivity for both the outgoing transmitted signal and the advanced and retarded fields of the distant receiving antenna. It is also capable of providing the directional reception needed to suppress the retarded fields of the distant receiving antenna. But it can be harder to set up than the simpler phased-array due to the critical dimensions and specifications that must be achieved during assembly.

The embodiments of FIGS. 4 and 5 provide two examples of the use of a directional coupler to recover the advanced (and retarded) fields of the distant receiving antenna that propagate down the feedline from the transmitting antenna to the transmitter. While in some sense simpler then the antenna systems based on the “phased array” principle, they could in operation be liable to spurious signal generation due to the wind or ground motion that changed—by local mechanical means—the feedpoint impedance of the transmitting antenna. But ignoring that problem, these two designs would be the easiest to manufacture.

### Specific Implementation of Receiving Station Circuitry

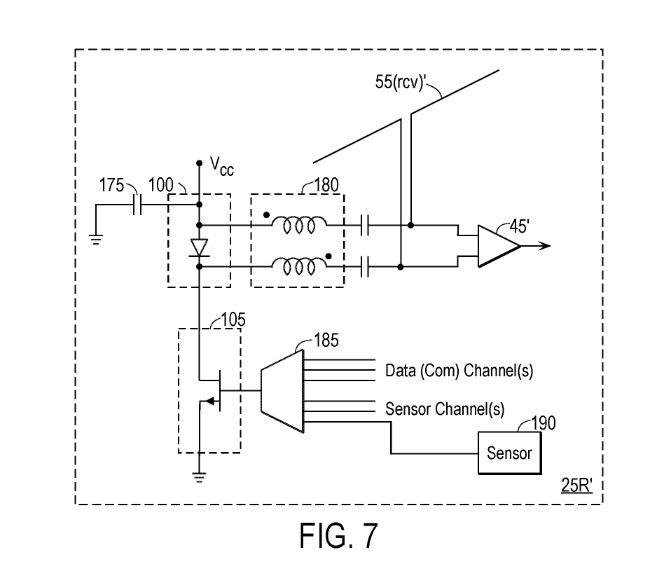

FIG. 7 is a schematic showing one specific implementation of receiving station circuitry that is suitable for use in the embodiments of FIGS. 2 through 6. For definiteness, the reference numerals corresponding to FIG. 2 will be used. In particular, this schematic shows specific implementations of the variable terminating resistor 100 that is connected between the input terminals of receiver 70(adv), and of the modulation circuit 105 that varies or modulates the resistance of the terminating resistor.

Variable terminating resistor 100 is implemented by a PIN diode, and modulation circuit 105 is implemented as a standard junction-type field effect transistor (FET). The PIN diode's resistance is set (and modulated) by the current flowing through the channel of the FET, which provides a current to the PIN diode˜Vin*Gₘ where the quantity Gₘ is the FET's transconductance. Such FETs operate as close approximations to three-terminal current sources in which the current through the device (from drain to source) is set by the voltage applied between the gate and the source. This current is nearly independent of the voltage applied to the drain. A positive DC power supply is required to provide the drain voltage needed for operation (Vcc). A Vcc bypass capacitor 175 between Vcc and ground is provided to keep the AC voltage at that end of the PIN diode at 0 volts regardless of the current drawn through the PIN diode.

A balun 180 comprising a bifilar toroidal winding is provided to isolate the PIN from the antenna. The balun should be wound around a suitable ferrite toroid core with a twisted pair of conductors whose surge impedance is the same as the surge impedance of the feedline. In this implementation the feedline's impedance is equal to the dipole's nominal impedance Z₀ and the feedline's length is an integral number of half wavelengths (including the length of the windings on the balun.

The FET gate is driven by a modulation input signal, whose DC level can be adjusted to set the “quiescent current” through the PIN diode to set the RF resistance of the PIN diode equal to the surge impedance of the feedline. The modulation applied to the FET's gate will then vary the impedance of the PIN diode to vary the current flowing through the elements of the dipole receiving antenna as required for operation of the system.

The feedline could be either coaxial cable (in which case another balun will be required between the dipole and the start of the coaxial cable) or some form of a two-wire balanced transmission line or waveguide. The incorporation of the toroid balun at the junction with the input terminals to the receiver makes the “impedance modulator” insensitive to the type (coax or balanced two-wire) of feedline used in the receiving station.

A variation of this “impedance modulator” would be to provide a tunnel diode instead of a PIN diode to provide a modulated negative resistance to enhance the amplitude of the receiving station's advanced fields at the antenna and/or feedlines of the transmitting station.

In practice, the signals being applied to the FET's gate come from multiple sources (channels), which are fed to the inputs of a multiplexer 185. In a typical scenario, the incoming retarded signal will contain channel information specifying the source that is to provide the response. The invention is not limited to the type of information that is sent by the transmitting and receiving stations. While particular parameter values, e.g., frequencies, are not part of the invention, it is noted that the signals modulating the PIN diode are typically in the 10's to 100's of MHz, while the RF signals are in the GHz range.

As shown in FIG. 7, the inputs to multiplexer 185 include a number of communications channels and a number of sensor channels, one of which is shown as having a connected sensor 190. The operation of the system is the same whether the signal data is what would normally be thought of as communications data or sensor data. The significance of the sensor channels will be discussed in the section below under the subheading “Remote Telemetry.”

### Reflection of Advanced Fields

While the embodiments shown in FIGS. 2-7 have transmitting and receiving antennas that are simple dipole and Yagi antennas, embodiments could have antennas that include reflective surfaces (e.g., screens, plates, spherical and parabolic reflectors). When such reflecting elements are used, a somewhat more basic approach needs to be used to identify the direction of the advanced fields as those fields converge from infinity towards their sources.

The most useful of those alternative approaches is based on the observation that the advanced and retarded fields generated by an oscillating current distribution are the time-reversed versions of each other. Therefore, if the distribution and direction of the conventional retarded fields can be determined including the effects of such reflecting surfaces, the distribution and direction of the source's advanced fields can be determined by reversing the direction in time of the source's retarded fields.

This approach is in general equivalent to the observation that the source's advanced fields obey the same laws of reflection and refraction (being governed by Maxwell's equations) as the source's time-reversed retarded fields. It is the interaction of the advanced fields from the target with the transmitter's EMF that extracts the additional power from the EMF needed for energy conservation. In general the power attributable to the receiver's advanced fields is totally negligible in the absence of the interaction of the advanced fields of the receiver with the transmitter's EMF.

### Radar Systems Using Advanced Fields (Advanced-Field Radar Systems)

The advanced communications systems described above and some of the telemetry systems described below require modulation of the advanced fields generated by the oscillating currents induced in the surfaces of the distant receiving antennas to acquire data from the operators of the distant receiving station.

However, for radar and some telemetry systems the target cannot include a human or automated operator. Thus, another means must be employed to modulate the target's advanced fields as required for detection. The approach that has been used in conventional radar systems under these circumstances is to periodically sweep the angle of the transmitting station's retarded beam or beams to periodically illuminate the target leading the target to generate periodically modulated reflected or scattered waves that can be identified by the frequency with which they are modulated, and the direction at which the amplitude of that modulation is maximized.

Remote targets illuminated by a search radar generate both the advanced and retarded fields required by Maxwell's equations. Conventional radar systems detect the time-delayed reflections attributable to the retarded solutions to Maxwell's equations. However, radar systems according to embodiments of the present invention are based on the advanced fields emitted by the remote targets illuminated by the search radar system's transmitter and antenna.

In a conventional radar system, a transmitting radar site directs microwave energy toward a region that might contain a target, and detects the power reflected from one or more targets in the region. Embodiments of the invention, however, operate by detecting power absorbed by any target(s) in the region. This makes it possible to detect targets that, by design or otherwise, either absorb (rather than reflect) the incident microwave energy, or deflect the power reflected from the non-absorbing surfaces of the target at angles sufficient to insure that none of the reflected power is returned to the transmitting site. In either case, the target ultimately causes power from the illuminating radar beam to be absorbed.

For a target made of strongly absorbing materials like graphite fiber composites, it is immediately obvious that the target would absorb more power from the illuminating laser beam than an object of equivalent size and shape constructed using highly reflecting materials like aluminum.

In the case of a target whose surfaces are shaped to deflect the incident radar beam at angles sufficient to insure that little or none of the reflected radiation is returned to the transmitting site, the deflected radiation will also ultimately be absorbed, typically by surfaces that have absorption coefficients that differ from the areas immediately adjacent to the target.

In both of these cases, the advanced fields of the currents induced in the surfaces that ultimately absorb the incident radiation from the radar transmitter will typically have amplitudes that differ from the advanced fields attributable to the currents induced by the radar transmitter by the media that ultimately absorb the radiation that does not interact with the target.

An advanced-field radar system operates by measuring the amplitude of the target's advanced fields at the transmitting antenna, and comparing the amplitude of those advanced fields of the target with the advanced fields of whatever absorbing materials are present adjacent to or behind the target. The system is thus able to detect a non-reflecting target by detecting the anomalous absorption of the microwave radiation directed towards the target.

As in the case of the advanced-field communications systems described above, the amplitude of the advanced fields to be measured in such a system can be determined either by using a directional coupler to measure the change in the power absorbed by the oscillating current distribution established in the elements of the transmitting antenna by the radar transmitter (as shown in FIG. 3), or by using a second antenna adjacent to the transmitting antenna designed to optimize coupling to the advanced fields of the targets of the radar system while minimizing sensitivity to the much stronger local fields of the oscillating currents in the transmitting antenna (as shown in FIG. 2).

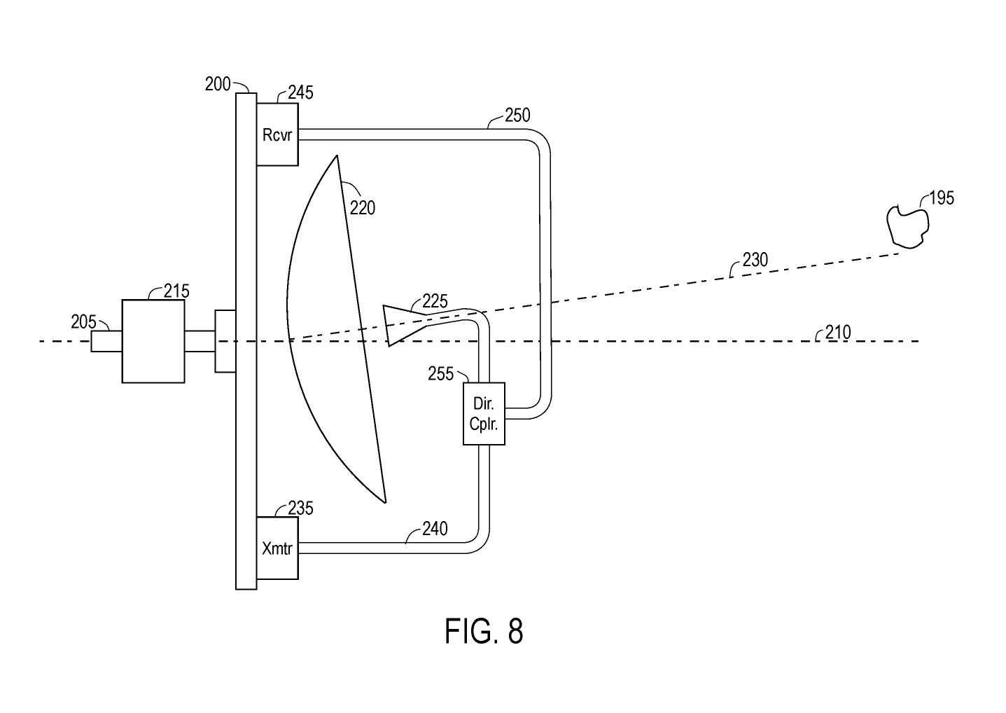

FIG. 8 is a schematic of an embodiment of a radar system (that can also be used for telemetry). In view of the small differences in the amplitudes of the advanced fields to be detected in such systems, embodiments of the present invention use a transmitting antenna whose beam can be deflected by small angles to alternately illuminate the area suspected to contain the target, and the adjacent areas characterized by the nominal absorption coefficients of the adjacent or background areas. Such mechanically or electronically “wobbled” illuminating beams can generate signals from the differing advanced fields generated by the currents induced in the target and background media that could be measured with greater sensitivity using phase sensitive detection at the “wobble” frequency of the illuminating beams from the transmitting antenna.

FIG. 8 shows the electronic components of an advanced field search radar system for detecting one or more targets 195. The electronic components are installed on a balanced turntable 200 mounted on a spindle 205 having a rotational axis 210. turntable 200 is driven by a mechanical drive 215 for rotation of the turntable. The radar system's electrical components include components corresponding generally to components in the transmitting station of FIGS. 3, 4, and 5.

In this case, the transmitting/receiving antenna includes a parabolic dish antenna 220 and a feed horn 225 for the parabolic dish antenna. The parabolic dish has an axis 230 that is at a small angle to rotational axis 210 of turntable 200. This angle is preferably greater than the resolution of the parabolic dish (which might be on the order of 1 degree), but generally less than 10 degrees). The other components include a transmitter 235, a waveguide feed 240 for the transmitter, a receiver 245, a waveguide feed 250 for the receiver, and a directional coupler 255 to isolate signal due to advanced fields of target. Thus, as the turntable spins, the antenna alternately illuminates the absorbing target, then the background behind the target, to produce a signal at receiver 245 that is modulated at the turntable's frequency of rotation.

Because the mass distribution of the radar system's components can be adjusted to achieve a “balanced mechanical load” for the bearings and drive system that support and drive the rotation of the antenna, the antenna can be rotated at frequencies in excess of 10 Hz to achieve the time-resolved tracking capabilities needed to follow moving targets without straining either the mechanical supports of the antenna system or the antenna's mechanical drive system.

Since the electronic components needed to detect the advanced fields of the target and adjacent background media in such a system would not interfere with the normal operation of pulsed radar systems designed to detect the reflected signals from their targets, the addition of the means needed to detect the advanced fields of the currents generated in targets by the outgoing pulses of radiation from the radar transmitter could provide a “dual-mode” detection capability.

Such a dual-mode system provides the simultaneous capability to operate in the normal mode by detection of the power reflected back towards the transmitting antenna by the target (susceptible to suppression by the implementation of the technologies used to reduce radar cross sections) and also the detection of the power absorbed by the target which would remain unaffected by those measures. Such a dual-mode radar system has a substantially improved detection capability for targets having low radar cross sections relative to systems confined to operate in the normal mode by detecting the power reflected from the targets of concern.

FIG. 8 shows one mechanism to impose periodic motion or “wobble” on the transmitting station's outgoing retarded beam. The advanced and retarded fields induced by this modulation can then be detected by looking for signals that vary in time at the same frequency of the wobbled transmitted beam, with the direction determined by the phase (of the wobbled beam) at which the amplitude of the detected signals are maximized. Alternatively, if the outgoing transmitted beam is swept at a constant frequency, the detected advanced and retarded signals from the target can be Fourier transformed to recover the received signal's distribution in time or angle as in a conventional telemetry or radar system.

### Remote Telemetry Using Advanced Fields (Advanced-Field Telemetry Systems)

As mentioned above, the inputs to multiplexer 185 in FIG. 7 include a number of communications channels and a number of sensor channels. Monitoring of sensors in a system is well known in a wide variety of environments (e.g., industrial processes, transportation systems, vehicles such as automobiles and trains). In a typical remote telemetry system, an interrogating system sends retarded fields to a remote site that can interrogate various sensors, and the remote site sends retarded fields back to the interrogating site.

The mechanisms for sensing advanced fields described in the context of communications systems described above apply in the context of telemetry, where the interrogating site is able to get an instantaneous “reading” of the sensors. This is especially significant where the sensor data suggests possible imminent catastrophic structural failure. The elimination of the round-trip time-of-flight delay can be particularly significant for monitoring sensors on spacecraft (for example, the earth and Mars can be 10's to 100's of miles apart).

A different approach to remote telemetry can be used where the remote object does not have a human or automatic mechanism to modulate the remote object's antenna's termination resistance and hence its advanced fields. The systems discussed above in connection with radar systems can be used if the property of the object being monitored is one that changes the amount of radiation that the object absorbs. As in the radar case, the object being monitored would not need a separate antenna system (receiving station). The property being monitored would be determined by the amount of power being absorbed.

### REFERENCES

The following references are hereby incorporated by reference for all purposes:

| Einstein_1909 | Albert Einstein, “On the present status of the |
|---|---|
| | radiation problem” Physikalische Zeitschrift, |
| | 10 (1909) page 185 |
| Madey_2015 | John M. J. Madey, P. Niknejadi, and J. M. D. |
| | Kowalczyk, “Maxwell's ‘Energy Integral’ and the |
| | need for time-symmetric electrodynamics” not |
| | published or submitted |
| Niknejadi_2015 | Pardis Niknejadi, John M. J. Madey, and Jeremy |
| | M. K. Kowalczyk, “Radiated power and radiation |
| | reaction forces of coherently oscillating charged |
| | particles in classical electrodynamics” Phys. |
| | Rev. D. 91 (May, 2015) |
| Panofsky_1962 | Wolfgang K. H. Panofsky and Melba Phillips, |
| | “Classical Electricity and Magnetism” 2nd Ed. |
| | (Addison-Wesley Publishing Company, Inc., |
| | Reading MA, 1962; republished Courier Dover |
| | Publications, Mineola NY, 2012) pages 394-398 |
| Schot_1992 | Steven H. Schot, “Eighty Years of Sommerfeld's |
| | Radiation Condition” Historia Mathematica 19 |
| | (1992) page 385 |
| Smith_2015 | Steven Smith and John M. J. Madey, “Role of |
| | dissipative boundary conditions in the deter- |
| | mination of the direction of time in classical |
| | electrodynamics” submitted to Reviews of Modern |
| | Physics |
| Wheeler_1945 | John A. Wheeler and Richard P. Feynman, |
| | “Interaction with the Absorber as the Mechanism |
| | of Radiation” Reviews of Modern Physics 17, 157 |
| | (1945). |

### CONCLUSION

In conclusion, it can be seen that aspects of the present invention provide for instantaneous communications, radar, and telemetry. The embodiments of the invention can be implemented with known technology.

While the above is a complete description of specific embodiments of the invention, the above description should not be taken as limiting the scope of the invention as defined by the claims.

What is claimed is:

1. A communications system comprising a transmitting station and a receiving station separated by a distance that results in a particular time-of-flight interval, wherein:
A(1) the transmitting station comprises,
a transmitting-station antenna subsystem,
a transmitting section, and
a receiving section;
A(2) the transmitting section comprises,
a transmitting-station transmitter, and
a first transmitting-station feedline coupled to the transmitter at one end and to the transmitting-station antenna subsystem at the other end;
A(3) the receiving section comprises,
a transmitting-station receiver, and
a second transmitting-station feedline coupled to the transmitting-station antenna subsystem at one end and to the transmitting-station receiver at the other end;
A(4) the receiving station comprises,
a receiving-station antenna subsystem,
a receiving-station feedline,
a receiving-station receiver having input terminals,
a variable terminating resistor across the receiving-station receiver's input terminals, and
a mechanism for modulating the resistance of the terminating resistor with signal information to be communicated to the transmitting station;
B(1) electrical signals generated by the transmitting-station transmitter are communicated along the first transmitting-station feedline to the transmitting-station antenna subsystem, which provides retarded radiation directed toward the receiving station;
B(2) the retarded radiation directed toward the receiving station impinges on the receiving-station antenna subsystem and electrical signals are communicated on the receiving-station feedline to the receiving-station receiver;
B(3) the modulation of the load resister generates advanced and retarded signals in the receiving-station feedline, which are communicated to the receiving-station antenna subsystem, resulting in (a) a retarded wave propagating outward from the receiving station, and
(b) a time-reversed advanced wave from infinity converging on the receiving station at the same time that the retarded wave diverges from the receiving station;
B(4) the advanced radiation converging on the receiving station reaches the transmitting station earlier than it reaches the receiving station by the particular time-of-flight interval; and
B(5) the advanced radiation received by the transmitting-station antenna subsystem is communicated along the second transmitting-station feedline to the transmitting-station receiver.

2. The communications system of claim 1 wherein:
the transmitting-station antenna subsystem uses the same antenna to send retarded radiation to the receiving station and to receive the advanced radiation; and
the first and second transmitting-station feedlines share a common portion at the antenna and are separated into separate portions by a directional coupler with one portion being connected to the transmitting-station transmitter and one portion connected to the transmitting-station receiver.

3. The communications system of claim 1 wherein:
the transmitting-station antenna subsystem uses separate transmitting and receiving antennas to send retarded radiation to the receiving station and to receive the advanced radiation; and
the first and second transmitting-station feedlines are separate feedlines with one connected between the transmitting-station transmitting antenna and the transmitting-station transmitter, and the other connected between the transmitting-station receiving antenna and the transmitting-station receiver.

4. The communications system of claim 1 wherein:
the transmitting-station antenna subsystem comprises a transmitting antenna as part of the transmitting section, and first and second receiving antennas as part of the receiving section;
the first and second receiving antennas are on opposite sides of the transmitting antenna with the first receiving antenna ¼ wavelength farther from the receiving station than the transmitting antenna, and the second receiving antenna ¼ wavelength closer to the receiving station than the transmitting antenna;
the receiving section comprises,
a hybrid coupler, and
first and second connections connecting the first and second antennas to the A and B ports of the hybrid coupler,
wherein the second connection introduces a 180-degree electrical delay in the phase of the transmitted signal relative to the first connection, and the transmitting-station receiver is connected to the hybrid coupler's A+B port.

5. The communications system of claim 1 wherein:
the transmitting-station antenna subsystem comprises first and second shared antennas;
the first shared antenna is ¼ wavelength farther from the receiving station than the second shared antenna;
a shared portion of the transmitting station comprises,
first and second directional couplers, each having first and second in-line ports, and a coupled port,
first and second shared feedline segments connecting the first and second shared antennas to respective first in-line ports of the first and second directional couplers,
wherein the second shared feedline segment introduces a 90-degree electrical delay in the phase of transmitted signals relative to the first shared feedline segment;
the transmitting section comprises,
a transmitting hybrid coupler whose A+B port is connected to the transmitting-station transmitter, and
respective first and second transmitting-section feedline segments connecting the transmitting hybrid coupler's A and B ports to respective second in-line ports of the first and second directional couplers; and
the receiving section comprises,
a receiving hybrid coupler whose A−B port is connected to the transmitting-station receiver, and
respective first and second receiving-section feedline segments connecting the receiving hybrid coupler's A and B ports to respective coupled ports of the first and second directional couplers.

6. A transmitting station for use in a communications system where the transmitting station sends retarded electromagnetic waves to a receiving station, and receives advanced and retarded electromagnetic waves from the receiving station in response to the set retarded electromagnetic waves, the transmitting station comprising:
a transmitting-station antenna subsystem;
a transmitting section comprising,
a transmitting-station transmitter, and
a first transmitting-station feedline coupled to the transmitting-station transmitter at one end and to the transmitting-station antenna subsystem at the other end; and
a receiving section comprising,
a transmitting-station receiver, and
a second transmitting-station feedline coupled to the transmitting-station antenna subsystem at one end and to the transmitting-station receiver at the other end;
wherein (a) electrical signals generated by the transmitting-station transmitter are communicated along the first transmitting-station feedline to the transmitting-station antenna subsystem, which provides retarded electromagnetic waves directed toward the receiving station, and (b) electrical signals generated by the advanced electromagnetic waves from the receiving station are communicated along the second transmitting-station feedline to the transmitting-station receiver (c) the signals resulting from the received electromagnetic advanced waves arrive at the same time as the signals from the transmitting-station transmitter are generated.

7. The transmitting station of claim 6 wherein:
the transmitting station comprises a directional coupler;
the transmitting-station antenna subsystem uses the same antenna to send retarded radiation to the receiving station and to receive the advanced radiation; and
the first and second transmitting-station feedlines share a common portion at the antenna and are separated into separate portions by the directional coupler with one portion being connected to the transmitting-station transmitter and one portion connected to the transmitting-station receiver.

8. The transmitting station of claim 6 wherein:
the transmitting-station antenna subsystem uses separate transmitting and receiving antennas to send retarded radiation to the receiving station and to receive the advanced radiation; and
the first and second transmitting-station feedlines are separate feedlines with one connected between the transmitting-station transmitting antenna and the transmitting-station transmitter, and the other connected between the transmitting-station receiving antenna and the transmitting-station receiver.

9. A receiving station for use in a communications system where a receiving station receives retarded electromagnetic waves from the transmitting receiving station, and sends advanced and retarded waves to the transmitting station, the receiving station comprising:
a receiving-station antenna subsystem;
a receiving-station receiver having input terminals,
a variable terminating resistor across the receiving-station receiver's input terminals;
a receiving-station feedline coupled to the receiving-station antenna subsystem and the receiving-station receiver; and
a mechanism for modulating the resistance of the terminating resistor with signal information to be communicated to the transmitting station;
the modulation of the resistance of the terminating resistor generates signals in the receiving-station feedline, which are communicated to the receiving-station antenna subsystem, resulting in
(a) a retarded wave propagating outward from the receiving station, and
(b) an advanced wave propagating inward from infinity to the receiving station,
wherein the retarded and advanced waves are time-reversed versions of each other so that the advanced wave converges on the receiving station at the same time that the retarded wave diverges from the receiving station.

10. The receiving station of claim 1 wherein:
the variable resistor is comprises a PIN diode; and
the mechanism for modulating the resistance of the terminating resistor comprises a junction field-effect transistor.
